(19) United States
(12) Patent Application Publication
(10) Pub. No.: US 2005/0120046 A1
(43) Pub. Date: Jun. 2, 2005

(54) User interaction and operation-parameter determination system and operation-parameter determination method

(75) Inventors: Kenichiro Nakagawa, Tokyo (JP); Makoto Hirota, Tokyo (JP); Hiroki Yamamoto, Tokyo (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/999,787

(22) Filed: Nov. 29, 2004

(30) Foreign Application Priority Data
Dec. 2, 2003 (JP) 2003-403364

(51) Int. Cl. G06F 7/00

(52) U.S. Cl. 707/102

(57) ABSTRACT

The present invention provides an interaction-state detection unit and an interaction-state capturing unit for detecting and capturing the current state of an interaction with a user. The present invention further provides a table storing interaction-state data and operation parameters that are paired with one another, an operation-parameter search unit for searching across the table based on the captured interaction state, an operation-parameter integration unit for generating at least one integrated operation parameter that resolves at least one contradiction between searched operation parameters, and an operation-parameter output part for outputting the integrated operation parameter generated by the operation-parameter integration unit.

### BACKGROUND OF THE INVENTION

1. Field of the Invention

The present invention relates generally to user interaction systems and methods and more specifically to user interaction systems and methods for determining operation parameters.

2. Description of the Related Art

Recently, speech-interaction systems have become more prevalent as standardization is achieved. Examples of such systems are car-navigation systems, automatic call centers and so forth. Recent speech interaction specifications such as VoiceXML have become standardized. See (http://www.w3.org/TR/voicexm120/) and Multimodal Interaction (http://www.w3.org/TR/mmi-framework/), for example.

The above-described interaction systems are referred to as “system-initiative” systems because they can lead users during an interaction. Such a system will typically ask questions to provide context so that users can reply. The following route-guidance system is an example, where S indicates a system output and letter U indicates a user response.
S: “This is Route-guidance system.”
S: “Please say your starting location.”
U: “Tokyo.”
S: “Please say your destination location.”
U: “Osaka.”
S: “Are you sure it is from Tokyo to Osaka?”
U: “Yes.”,
etc.

Although, the “system-initiative” interaction system can lead an interaction, it is difficult for the system to notify the user about when (and what type of data) should be input.

Accordingly, the following input errors often occur: (1) the user fails to input data because the user does not realize the system is finished; (2) the user inputs data before the system is finished; (3) after being asked to input data, the user may be organizing the user's thoughts and may input unrecognizable words such as “uh”, “well”, and so forth or the user may need to cough, etc.

To resolve input errors, conventional “system-initiative” interaction systems typically prompt the user for information by using a beep sound. The following is an example of the above-described method.
S: “This is a route-guidance system.”
S: “Please say your starting location after the beep.” (beep)
U: “Tokyo.”

Japanese Patent Laid-Open No. 2002-123385, for example discloses a method for using prompts to receive user input information. Another known method can change speech-synthesis parameters according to the interaction mode of a user. However, these conventional []systems are unable to resolve all of the above-mentioned disadvantages. Another disadvantage of conventional systems is that they cannot notify users about the type of input (speech, push buttons, and so forth) that can be processed by such systems.

### SUMMARY OF THE INVENTION

Accordingly, to resolve one or more disadvantages of conventional systems, the present invention provides a user interaction system for determining operation parameters, an operation-parameter determination system and an operation-parameter determination method for outputting an operation parameter according to the state of interaction with a user, and a control program that can be read by a computer.

Further, the present invention is directed to provide an electronic system, a speech-synthesis system, and an interaction system that are used for correctly notifying the user of the timing and type of input by using the operation parameter determined based on the interaction state.

According to the present invention, an operation parameter based on the state of an interaction with an outside source can be provided. Further, users can be correctly notified about the timing and type of input by using the operation parameter that was determined based on the state of the interaction with the outside source.

Further features and advantages of the present invention will become apparent from the following description of the embodiments (with reference to the attached drawings).

### BRIEF DESCRIPTION OF THE DRAWINGS

FIG. 1 is a functional block diagram of an operation-parameter determination system according to embodiments of the present invention.

FIG. 2 is a flowchart showing the details of operations performed by the operation-parameter determination system shown in FIG. 1.

FIG. 3 is a block diagram illustrating the configuration of a first embodiment of the present invention.

FIG. 4 shows a schematic view of an example car-navigation system and an example GUI screen.

FIG. 5 shows an interaction state/operation parameter correspondence table according to the first embodiment of the present invention.

FIG. 6A shows an example animated icon displayed on the GUI screen.

FIG. 6B shows another example animated icon displayed on the GUI screen.

FIG. 7 is a block diagram illustrating the configuration of a second embodiment of the present invention.

FIG. 8 is a flowchart illustrating operations performed by a speech-synthesis system according to the second embodiment.

FIG. 9 shows an interaction state/operation parameter correspondence table used for the second embodiment.

FIG. 10 shows example details of interactions according to the second embodiment.

FIG. 11 partly shows the interaction contents according to the second embodiment, where the interaction contents are written in VoiceXML.

FIG. 12 shows a third embodiment of the present invention.

### DETAILED DESCRIPTION OF THE EMBODIMENTS

A user interaction system for determining operation parameters, an electronic system, a speech-synthesis system, an operation-parameter determination method, and a control program that can be read by a computer according to embodiments of the present invention will now be described with reference to the attached drawings. The above-described operation-parameter determination system is used for a car-navigation system, an automatic ticket-reservation system, etc.

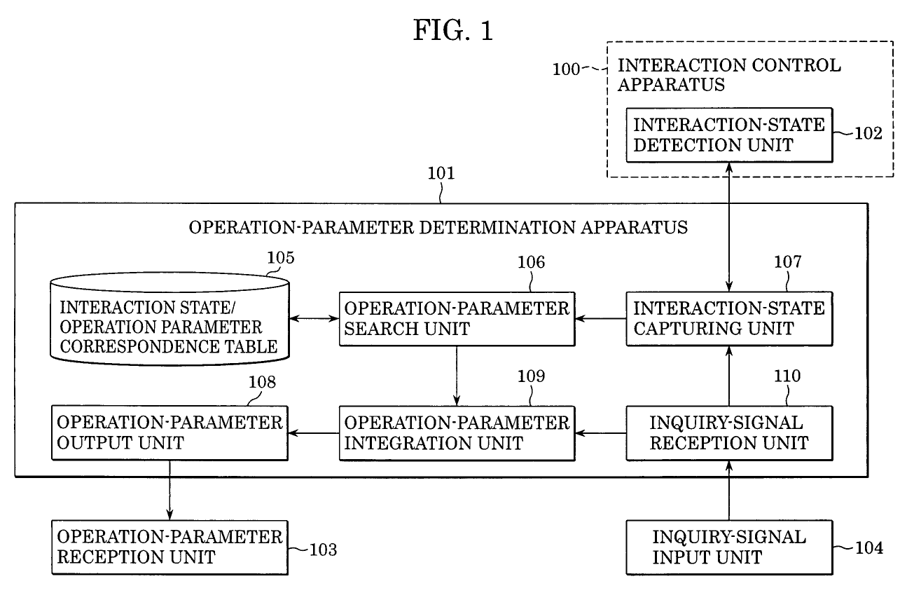

FIG. 1 is a functional block diagram of the above-described operation-parameter determination system designated by reference numeral 101.

The operation-parameter determination system 101 can generate and output operation parameters that specify an operation to be taken by the system, wherein said operation is based on the current interaction state detected at the instant where an inquiry signal that inquires about the operation parameters is received. An interaction-control system 100 for controlling an interaction with a user, an operation-parameter reception unit 103 for receiving the operation parameters transmitted from the operation-parameter determination system 101, and an inquiry-signal input unit 104 for transmitting an inquiry signal to the operation-parameter determination system 101, so as to inquire about the operation parameters, are externally connected to the operation-parameter determination system 101. The interaction-control system 100 has an interaction-state detection unit 102 for detecting the current interaction state. The current interaction state denotes information about system state such as “waiting for user input”, “system outputting”, and so forth.

The operation-parameter determination system 101 includes an inquiry-signal reception unit 110. The inquiry-signal reception unit 110 monitors the inquiry signal externally input from the inquiry-signal input unit 104. In the present embodiment, the inquiry signal may be a button event transmitted from a push button or the like or a specific memory image set to a predetermined memory area.

Upon receiving the inquiry signal, the inquiry-signal reception unit 110 notifies both an interaction-state capturing unit 107 and an operation-parameter integration unit 109. Then, the interaction-state capturing unit 107 directs the interaction-state detection unit 102 to detect the current interaction state.

The captured interaction-state data is transmitted to an operation-parameter search unit 106. The operation-parameter search unit 106 searches an interaction state/operation-parameter correspondence table 105, described with reference to FIG. 5, which stores both interaction-state data and operation parameters that are paired with one another. The search is conducted to find operation parameters corresponding to the captured interaction-state data.

The operation parameters obtained by the above-described search are transmitted to the operation-parameter integration unit 109. The operation-parameter integration unit 109 performs integration processing, where the number of operation parameters obtained by the search is two or more, so as to resolve contradictions between the operation parameters. For example, when “Utterance_speed=200 ms/syllable” and “Utterance_speed=300 ms/syllable” are obtained. They contradict each other, because they set different values to a same variable. The operation-parameter integration unit resolves them, and “Utterance_speed=250 ms/syllable” is outputted. Then, the operation parameters are transmitted to an operation-parameter output unit 108 and output to the operation-parameter reception unit 103.

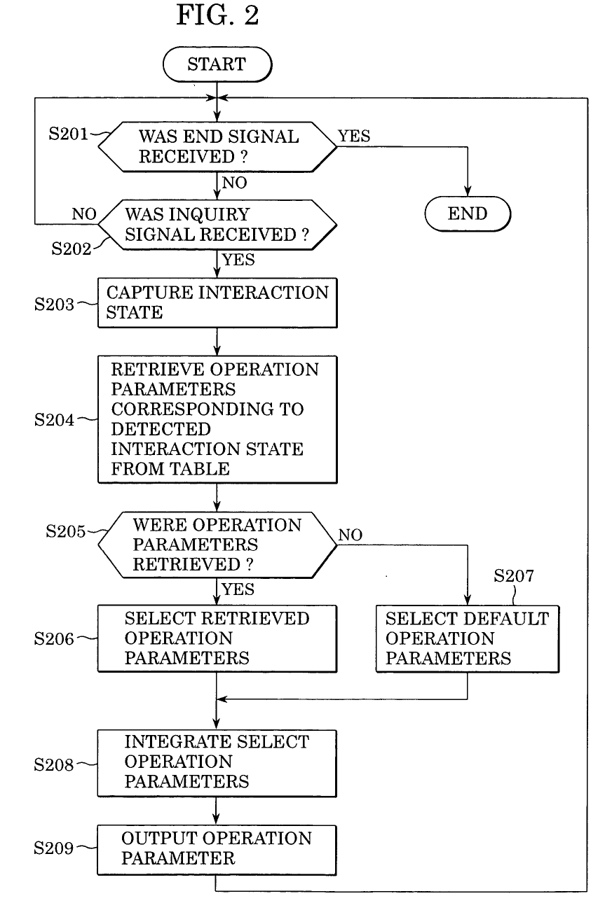

FIG. 2 is a flowchart illustrating the details of processing procedures performed by the operation-parameter determination system 101 shown in FIG. 1. The operation-parameter determination system 101 starts performing the processing procedures after booting up.

First, it is determined whether an end signal was received (step S201) from the user. The end signal is issued when an end button (not shown) provided on the operation-parameter determination system 101 is pressed down, for example. Where no end signal is detected, the operation-parameter determination system 101 proceeds to step S202. Otherwise, the operation-parameter determination system 101 terminates the processing.

Next, it is determined whether an inquiry signal was transmitted from the inquiry-signal input unit 104 to the inquiry-signal reception unit 110 (step S202). The inquiry-signal is used to request the operation parameters from the system. The operation-parameter determination system 101 enters and stays in standby mode until the inquiry-signal reception unit 110 receives the inquiry signal.

Upon receiving the inquiry signal, the inquiry-signal reception unit 110 informs both the interaction-state capturing unit 107 and the operation-parameter integration unit 109. Then, the interaction-state capturing unit 107 directs the interaction-state detection unit 102 to detect the current interaction state, which is then captured by the interaction-state capturing unit 107 (step S203). Here, the interaction state denotes information indicating a predetermined interaction state, such as “waiting for user input”, “system outputting”, and so forth. A plurality of interaction states may be detected, as required.

Next, operation parameters corresponding to the entire detected interaction states are retrieved from the interaction state/operation parameter correspondence table 105 (step S204). Where operation parameters corresponding to the detected interaction states exist in the interaction state/operation parameter correspondence table 105 (step S205), the entire operation parameters are selected (step S206). If there are no operation parameters corresponding to the detected interaction states, default operation parameters are selected (step S207).

Where at least two operation parameters are selected, the operation-parameter integration unit 109 performs integration processing, so as to resolve contradictions, if any between the selected operation parameters (step S208). The details of the integration processing will now be described. First, where the operation-parameter search unit 106 obtains contradictory operation parameters including an operation parameter indicating “Utterance_speed−=50 ms/syllable” (actual utterance speed slows down 50 ms/syllable) [WHAT IS THIS] and an operation parameter indicating “Utterance_speed−=100 ms/syllable”, for example, the above-described two operation parameters are changed into an operation parameter indicating “Utterance_speed−=150 ms/syllable”. Further, where the operation-parameter search unit 106 obtains operation parameters including an operation parameter indicating “Utterance_speed=200 ms/syllable” (utterance speed is set to 200 ms/syllable) and an operation parameter “Utterance_speed=300 ms/syllable”, the above-described operation parameters are changed into one operation parameter indicating “Utterance_speed=250 ms/syllable”, so as to meet halfway therebetween.

After the contradiction between the operation parameters is resolved, the operation parameters are transmitted from the operation-parameter output unit 108 to an external location (step S209). Then, the process returns to step S201, wherein the operation-parameter determination system 101 enters and stays in the standby mode until the inquiry-signal reception unit 110 receives an inquiry signal.

In this manner, operation parameters corresponding to a user interaction state can be output.

### First Embodiment

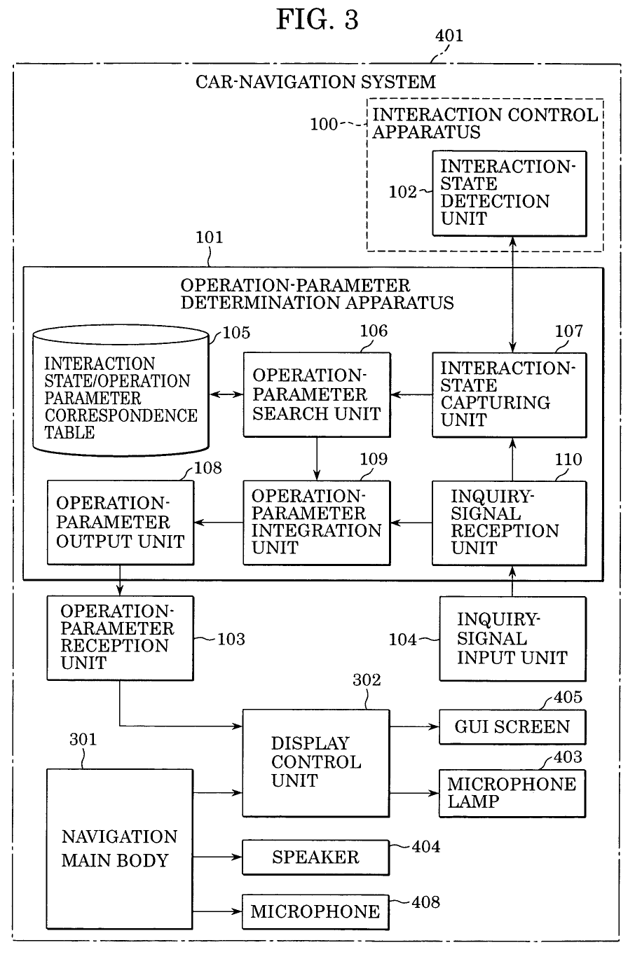

An example where the operation-parameter determination system 101 shown in FIG. 1 is used for a car-navigation system will now be described with reference to FIGS. 3 to 6.

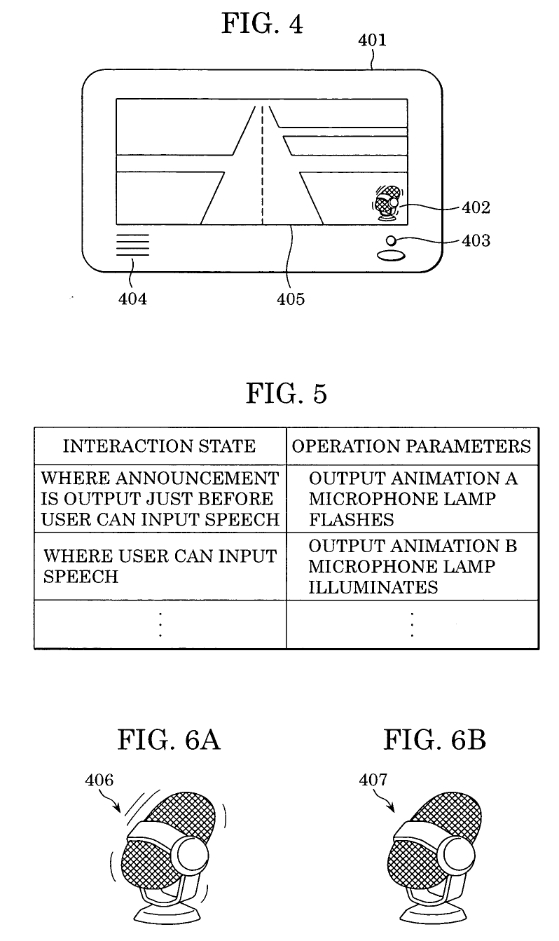

FIG. 3 is a block diagram illustrating the configuration of a first embodiment of the present invention. In FIG. 3, a car-navigation system 401 including the operation-parameter determination system 101 is shown. FIG. 4 shows an example of the car-navigation system 401 and a GUI screen 405.

In this car-navigation system 401, an operation parameter transmitted from the operation-parameter determination system 101 is supplied to a display control unit 302 via the operation-parameter reception unit 103. In this embodiment, an inquiry signal is transmitted at regular intervals, so as to obtain operation parameters.

The display control unit 302 has the function of inputting image data such as map data transmitted from a navigation main body 301 and displaying the image data on the GUI screen 405. The display control unit 302 further has the GUI-change function for changing the shape of an icon or the like displayed on the GUI screen 405 according to the operation parameter transmitted from the operation-parameter determination system 101 and the function of controlling the lighting state of a microphone lamp 403. A speaker 404 and a microphone 408 are connected to the navigation main body 301.

In general, car-navigation systems are known as “mixed-initiative” because they combine both “system-initiative” interaction and “user-initiative” interaction. Thus, the car-navigation system 401 can process the following interaction.
U01: (The user presses a button to request) “A convenience store nearby.”
S02: “There are four convenience stores in a five-minute area in the traveling direction.”
S03: “The nearest convenience store is ABC.”
S04: “Is it fine with you?”
U05: “Yes.”,
etc.
(Letter S indicates a system announcement output from the system and letter U indicates an input by a user.)

In such a system, the user can determine when to answer after the announcement is made based on the context of the announcement. However, where the user cannot concentrate on interactions because of driving, or where the user is not accustomed to operating the car-navigation system, the user often cannot determine the input timing appropriately. In the present invention, therefore, an animated icon 402 functioning as a vocalization guide is displayed on the GUI screen 405, as shown in FIG. 4.

The interaction state/operation parameter correspondence table 105 used by the operation-parameter determination system 101 stores data including interaction states and operation parameters that are paired with one another. For example, FIG. 5 shows the details of such data.

As a result, when an announcement is output before the user can input speech data (where the system announcement corresponding to S04 is output), an operation parameter indicating the animation A is output and a flashing microphone lamp is output. Subsequently, an animated icon 406 shown in FIG. 6A is displayed on the GUI screen 405 of the car-navigation system 401 and the microphone lamp 403 flashes.

Further, where a system announcement S04 is ended, so that the user can input speech data, an operation parameter indicating “animation B is output and microphone lamp illuminates” can be retrieved from the interaction state/operation parameter correspondence table 105. Subsequently, an animated icon 407 shown in FIG. 6B is displayed on the GUI screen 405 and the microphone lamp 403 illuminates.

Accordingly, because the above-described changes are visual, the user can output speech data after the system announcement occurs, or the user can input speech data at the present. Subsequently, the user can perceive the input timing, even though he/she cannot concentrate on system announcements because of driving, or hear the system announcements temporarily due to noise therearound or the like.

### Second Embodiment

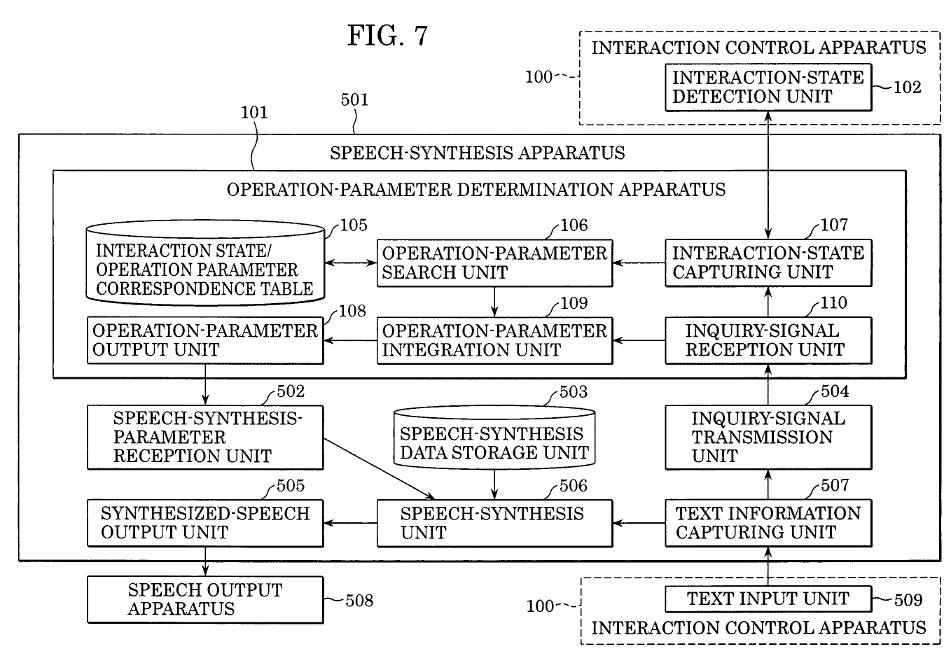

In a second embodiment of the present invention, an example speech-synthesis system using the operation-parameter determination system 101 shown in FIG. 1 will be described with reference to FIGS. 7 to 12.

FIG. 7 is a block diagram illustrating the second embodiment of the present invention. More specifically, this drawing shows the functional configuration of a speech-synthesis system 501 including the operation-parameter determination system 101 shown in FIG. 1.

The speech-synthesis system 501 further includes a speech-synthesis parameter reception unit 502 and an inquiry-signal transmission unit 504 that correspond to the operation-parameter reception unit 103 and the inquiry-signal input unit 104, respectively. The speech-synthesis system 501 further includes a text-information capturing unit 507 for capturing text information from outside the speech-synthesis system 501, a speech-synthesis data storage unit 503 for storing speech-synthesis data, a speech-synthesis unit 506 for performing speech-synthesis processing, and a synthesized-speech output unit 505 for outputting synthesized speech generated by the speech-synthesis unit 506.

A text input unit 509 for transmitting text information to the text-information capturing unit 507 and a speech output system 508 formed as a speaker or the like for outputting the synthesized speech transmitted from the synthesized-speech output unit 505 are externally connected to the speech-synthesis system 501. A text input unit 509 is provided in the interaction control system 100.

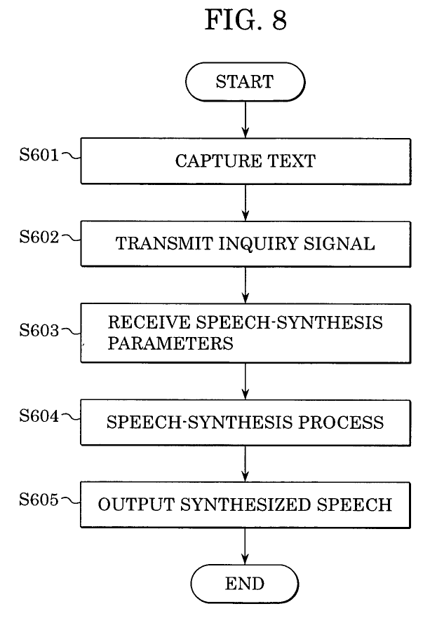

FIG. 8 is a flowchart illustrating operations performed by the speech-synthesis system 501.

The speech-synthesis system 501 captures text information transmitted from the external text input unit 509 via the text-information capturing unit 507 (step S601). When the text information is captured, the signal transmission unit 504 is notified that the text information is captured.

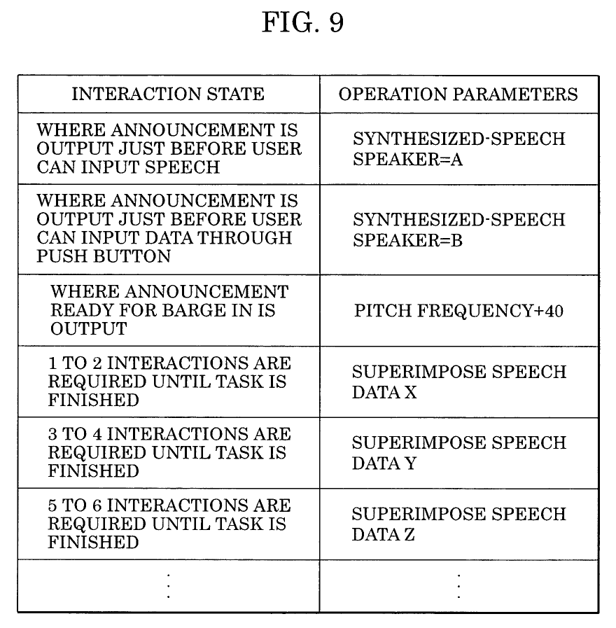

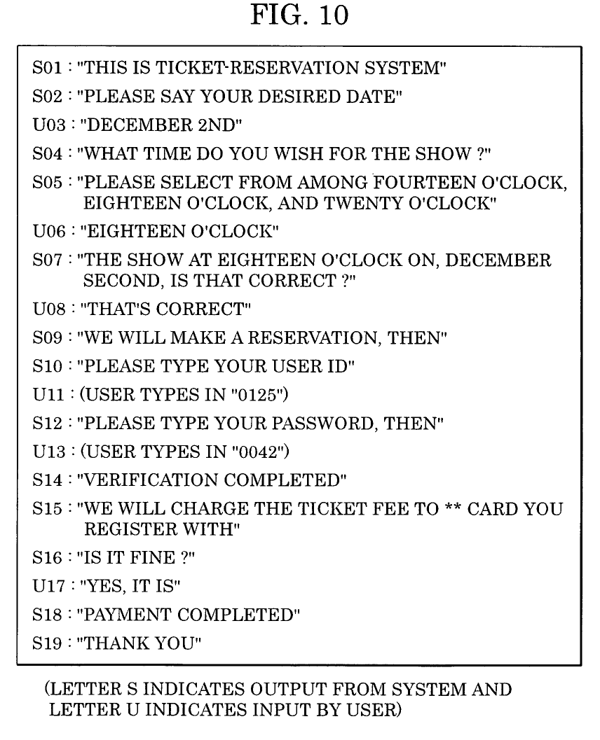

The inquiry-signal transmission unit 504 issues an inquiry signal for inquiring about an operation parameter to the inquiry-signal reception unit 110 in the operation-parameter determination system 101 (step S602). Subsequently, an operation parameter corresponding to the current interaction state is determined by referring to the interaction state/operation parameter correspondence table 105 as further discussed with reference to FIG. 9. The operation parameter is then transmitted to the speech-synthesis parameter reception unit 502 (step S603). Here, a speech-synthesis parameter is used, as the operation parameter.

The text information captured by the text-information capturing unit 507 is also transmitted to the speech-synthesis unit 506. The speech synthesis unit 506 performs speech-synthesis processing by using the speech-synthesis parameter obtained through the operation-parameter determination system 101, the text information, and speech-synthesis data (step S604). Conventional speech-synthesis processing is known and need not be discussed.

Synthesized speech generated by the speech-synthesis unit 506 is transmitted to the speech output system 508 outside the speech-synthesis system 501 via the synthesized-speech output unit 505 and output from the speech output system 508 (step S605).

FIG. 9 illustrates an example interaction state/operation parameter correspondence table 105 of this embodiment. This table stores detected interaction states and speech-synthesis operation parameters corresponding thereto. The detected interaction states and the speech-synthesis operation parameters are paired with one another.

Accordingly, the speech-synthesis system 501 can dynamically select speech-synthesis parameters based on the detected interaction state.

FIG. 10 illustrates user interaction with the speech-synthesis system 501 in the context of an automatic ticket-reservation system in accordance with an embodiment of the present invention.

In FIG. 10, the user interacts with the automatic ticket-reservation system by telephone such that the telephone push buttons and the user's voice are used as inputs. The output from the automatic ticket-reservation system is by voice.

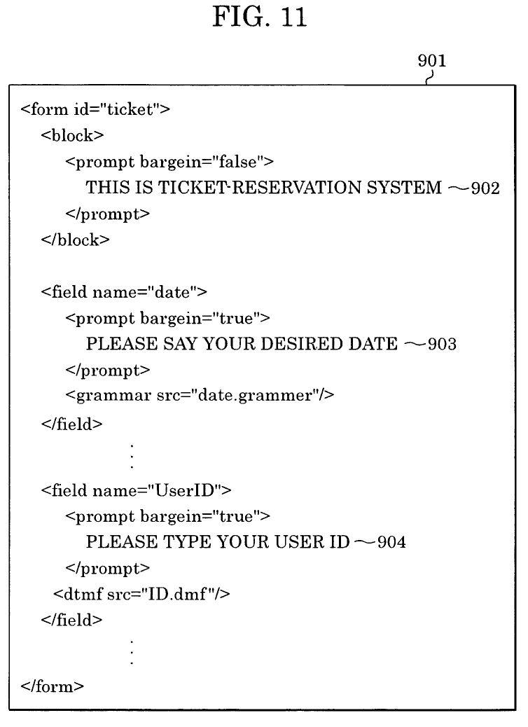

FIG. 11 shows part of interaction contents 901 according to this embodiment, where the interaction contents 901 are written in VoiceXML, for example.

The interaction-control system 100 reads the interaction contents 901 and controls the interaction between the user and the automatic ticket-reservation system.

The interaction-control system 100 inputs text information to the speech-synthesis system 501 by using the text input unit 509, so as to output each of the system announcements. For example, a system announcement 903 corresponding to an announcement S02 shown in FIG. 10 is output in the following manner. First, the interaction-control system 100 inputs text information corresponding to the announcement S02 to the speech-synthesis system 501 by using the text input unit 509, so as to output the system announcement S02. The text-information capturing unit 507 captures the text information and the inquiry-signal transmission unit 504 issues an inquiry signal to the operation-parameter determination system 101.

Upon receiving the inquiry signal via the inquiry-signal reception unit 110, the operation-parameter determination system 101 directs the interaction-control system 100 through the interaction-state capturing unit 107 to capture information about the current interaction state transmitted from the interaction-state detection unit 102.

Here, the interaction state can be any one of various exemplary states, which may be based on input type. The interaction state may be defined as the state where a system announcement is before speech input, or the state where a system announcement is before push-button input, and/or the state where a system announcement is ready for barge-in. A plurality of the above-described states may be output, as required. The system announcement ready for barge-in indicates that the system announcement can be interrupted by a user input. Where VoiceXML is used, a predetermined system announcement can be designated by a “barge in” attribute in a <prompt> tag, as the system announcement that is ready for barge-in. Further, it is possible to determine whether a predetermined announcement is an announcement just before speech input or an announcement just before push-button input by checking elements <grammar> and <dtmf> that are brother elements of <prompt>.

By translating the internal state of the automatic ticket-reservation system and the interaction contents 901, the operation-parameter determination system 101 determines that “a system announcement ready for barge-in is output” and “a system announcement just before the user can input speech data is output”, where the system announcement 903 corresponding to the announcement S02 is output. Subsequently, “pitch frequency+40” and “synthesized-speech speaker=A” shown in the interaction state/operation parameter correspondence table 105 in FIG. 9 are determined to be operation parameters corresponding to the above-described interaction state.

The operation-parameter determination system 101 outputs the above-described two operation parameters and the speech-synthesis system 501 generates a synthesized wave by using the above-described operation parameters and text information “Please say your desired date.” Here, the speaker of the synthesized speech is determined to be A and a synthesized speech is generated by increasing a default pitch frequency by as much as 40 Hz.

The generated synthesized speech is output to the user via a telephone line. The synthesized speech corresponding to the system announcement 903 notifies the user that he/she can input speech data, for example, after the system announcement 903 is finished. The synthesized speech further notifies the user that barge-in is permitted during the system announcement is made.

Further, it is possible to change from a predetermined operation parameter to another, based on the number of interactions required until a task (ticket reservation or the like) is finished. For example, the interaction state/operation parameter correspondence table 105 shows an instruction to superimpose predetermined sound data (e.g. scale wave) on the synthesized speech based on the number of interactions required until the task is finished. Subsequently, the user perceives how many interactions should be made until the task is finished by hearing the sound data superimposed on the synthesized speech.

### Third Embodiment

In a third embodiment of the present invention, the operation-parameter determination system 101 shown in FIG. 1 is used for form inputting by using a GUI screen and speech.

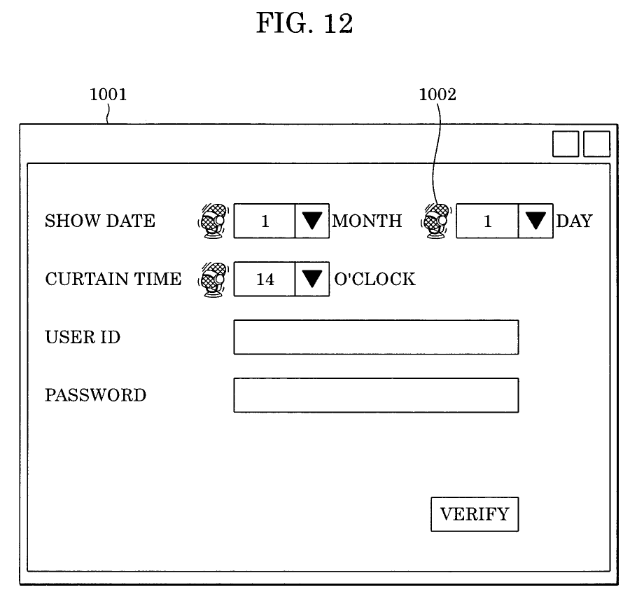

FIG. 12 shows a general form input screen illustrating a predetermined task of the automatic ticket-reservation system in the second embodiment.

Where a form input screen 1001 is displayed, as shown in this drawing, the user can fill in spaces in the form by using a mouse and a keyboard or inputting speech data through a microphone.

Where the form input screen 1001 ready for the speech inputting is displayed, the user may keep vocalizing data that cannot be input thereto. Therefore, it is effective to inform the user about which data can be input by speech. In this drawing, an animated icon 1002 is displayed near each of spaces that are ready for speech inputting as of this point.

The form and motion of the animated icon 1002 is changed according to the state of an interaction with the user. For example, the form and motion may be changed according to whether a system announcement is output. Further, during the output of the predetermined system announcement, the form and motion may be changed according to whether speech data can be input after the system announcement is finished.

The present invention is not limited to the systems according to the above-described embodiments, but can be used for a system including a plurality of devices and a system including only one device. Further, in another embodiment, the present invention can also be achieved by supplying a storage medium storing program code of software for implementing the functions of the above-described embodiments to a system or a system so that a computer (CPU, MPU, etc.) of the system or the system reads and executes the program code stored in the storage medium.

In that case, the program code itself, read from the storage medium, achieves the functions of the above-described embodiments, and thus the storage medium storing the program code constitutes the present invention. The storage medium for providing the program code may be, for example, a floppy (registered trademark) disk, a hard disk, an optical disk, a magneto-optical disk, a CD-ROM, a CD-R, a magnetic tape, a non-volatile memory card, a ROM, etc. Furthermore, not only by the computer reading and executing the program code, but also by the computer executing part of or the entire process utilizing an OS, etc. running on the computer based on instructions of the program code, the functions of the above-described embodiments may be achieved.

In another embodiment of the present invention, the program code read from the storage medium may be written to a memory of a function extension board inserted in the computer or a function extension unit connected to the computer. The functions of the above-described embodiments may be realized by executing part of or the entire process by a CPU, etc. of the function extension board or the function extension unit based on instructions of the program code.

While the present invention has been described with reference to what are presently considered to be the embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2003-403364 filed Dec. 2, 2003, which is hereby incorporated by reference herein.

1. A user interaction system for determining operation-parameters comprising:
a detection unit for detecting a current interaction state between a user and the user interaction system;
a search unit for searching a storage unit for at least one operation parameter that determines an operation to be taken by the user interaction system based on the detected current interaction state, wherein the storage unit stores one or more pairs of an operation parameter associated with an interaction state;
an integration unit for integrating searched operation parameters into at least one integrated operation parameter where more than one operation parameter corresponds to the detected current interaction state; and
an output unit for outputting the integrated operation parameter.

2. The user interaction system according to claim 1, wherein the integration unit integrates the searched operation parameters, so as to resolve at least one predetermined contradiction therebetween.

3. An electronic system including the user interaction system according to claim 1, the electronic system comprising:
a display unit for displaying information; and
a changing unit for changing display contents provided by the display unit based on the integrated operation parameter transmitted from the output unit.

4. A speech synthesis system including the user interaction system according to claim 1, the speech synthesis system comprising:
a text capturing unit for capturing text information; and
a speech synthesis unit for generating synthesized speech based on the integrated operation parameter transmitted from the output unit and the text information.

5. The user interaction system of claim 4 capable of interacting with an outside source responding to an input operation including external speech inputting and external control inputting,
wherein the detection unit detects a state just before speech inputting, a state just before control inputting, and/or a state where an input operation for interrupting a speech output transmitted from the interaction system can be done.

6. The user interaction system according to claim 5, further comprising:
a contents-reading unit for reading contents data including details of a predetermined interaction; and
an interaction control unit for controlling an interaction with an outside source by translating the contents data, where the interaction includes the speech output.

7. An operation-parameter determination method comprising:
a detecting step for detecting a current interaction state;
a searching step for searching for at least one operation parameter across a storage unit storing interaction-state information and at least one operation parameter that are paired with each other based on the detected interaction-state information;
an integration step for integrating the searched operation parameters into at least one integrated operation parameter; and
an output step for outputting the integrated operation parameter.

8. The operation-parameter determination method according to claim 1, wherein the integration step is performed for generating a predetermined operation parameter that resolves at least one contradiction between the searched operation parameters.

9. A control program that can be read by a computer, the control program comprising:
a detecting step for detecting information about the current interaction state;
a searching step for searching for at least one operation parameter across a storage unit storing interaction-state information and at least one operation parameter that are paired with each other based on the detected interaction-state information;
an integration step for integrating the searched operation parameters into at least one integrated operation parameter; and
an output step for outputting the integrated operation parameter.

10. The control program according to claim 9, wherein the integration step is performed for generating a predetermined operation parameter that resolves at least one contradiction between the searched operation parameters.

11. A storage medium that can be read by a computer, the storage medium storing the control program according to claim 10.

12. The method of claim 7 wherein the steps of detecting, searching, integration and output are performed in sequence.
